(19) United States
(12) Patent Application Publication
(10) Pub. No.: US 2025/0061815 A1
(43) Pub. Date: Feb. 20, 2025

(54) GUITAR TRAINING APPARATUS

(71) Applicants: Jeff Cameron, BONHAM, TX (US); Michael Cameron, BONHAM, TX (US)

(72) Inventors: Jeff Cameron, BONHAM, TX (US); Michael Cameron, BONHAM, TX (US)

(21) Appl. No.: 18/789,606

(22) Filed: Jul. 30, 2024

Related U.S. Application Data
(60) Provisional application No. 63/520,196, filed on Aug. 17, 2023.

(51) Int. Cl. G09B 15/06; G10D 1/04; G10D 3/04; G10D 3/12; G10D 3/14; G10H 1/00; G10H 7/00

(52) U.S. Cl. CPC G09B 15/06; G10D 1/04; G10D 3/04; G10D 3/12; G10D 3/14; G10H 1/0008; G10H 7/002; G10H 2220/191; G10H 2250/451

(57) ABSTRACT

A musical training apparatus that has a string board for holding guitar strings, the string board having a head stock positioned proximate an end thereof and tuning pegs positioned on and through the headstock. The invention includes an orthogonal extending member having a first end and a second end, the first end being coupled to the rear surface of the string board. The invention also has a belly plate having top surface and a bottom surface, the second end of the orthogonal extending member being coupled to the top surface of belly plate and a thigh brace having a thigh brace extension portion coupling a lower edge of the string board to a curved member.

### CROSS REFERENCE TO RELATED APPLICATION

This application claims the benefit of, and incorporates herein by reference, U.S. Provisional Application No. 63/520,196, filed Aug. 17, 2023 and U.S. Provisional Application No. 63/605,783, filed Dec. 4, 2023.

### TECHNICAL FIELD

The invention relates to musical instrument training apparatus and devices.

### BACKGROUND

An acoustic guitar is a stringed instrument that produces sound when the strings are plucked. The vibrations from the plucked strings travel through the guitar's bridge, top, sides, and back, and create sound from the sound hole. Acoustic guitars are often louder than electric guitars and can be played in many different ways, including fingerstyle, flatpicking, and strumming. They are also known as “hollow body guitars” or “classical guitars”. An acoustic guitar is seen in FIG. 1 (prior art). Acoustic guitar 100 has the following parts: body 101, bridge 102, neck 103, fretboard 104, headstock 105, tuning pegs 106, nut 107 and bridge pins 108.

Travis picking. also called pattern picking or the alternating-thumb style, refers to an accompaniment style on a guitar based on repeating a particular kind of right-hand pattern of thumb and finger moves throughout a song, adapting that pattern to the notes of each chord. and conforming to a specific way of choosing the bass notes played by the thumb. Taking a G chord, the picking is as follows:

The first step is to establish the bass notes. The bass notes are the notes played with the thumb, usually on the sixth. fifth. and fourth strings. On a G chord. the bass notes are on the sixth string and the fourth string.

Travis picking is always in 4/4 time which means there are four beats in every measure and every quarter note counts for one beat. Practicing the movement of the dominant hand on the body of a guitar when picking the strings, rather than strumming, requires the use an entire guitar. There is no lightweight portable device resembling a guitar body (without frets) that can be easily strapped to a human body and used to practice finger picking (e.g., Travis picking) or strumming progressions.

### SUMMARY

The invention is an apparatus, system and method for guitar training. It is a string board for holding 6 or 12 guitar strings, a set of guitar strings strung across a bridge and nut, each of which are positioned on the top surface of the string board; a pedestal or orthogonal extending member having a first end and a second end, the first end coupled to the bottom surface of the string board; a belly plate with a top surface and a bottom surface; the second end of the pedestal being coupled to the top surface of the belly plate; and the belly plate have a flat or generally curved contour configured to rest against the belly of the user. Further included is a thigh brace having a thigh brace extension portion coupled at a first end to the string board and a second end coupled to a curved portion operable to rest the invention on the thigh of the user. A first slot and second slot are provided through the belly plate to allow passage of a nylon web belt that is used to secure the invention against the midsection of the user's body. The strings are non-functional acoustically as the purpose is solely to practice right hand (for right handed players) guitar picking, although the strings can be coupled to sensors or switches operable to trigger an electronic sound representation of the picked string.

### DESCRIPTION OF THE DRAWINGS

For a better understanding of the present invention including the features, advantages and specific embodiments, reference is made to the following detailed description along with accompanying Figures.

FIG. 1 is a front view of an acoustic guitar (prior art);

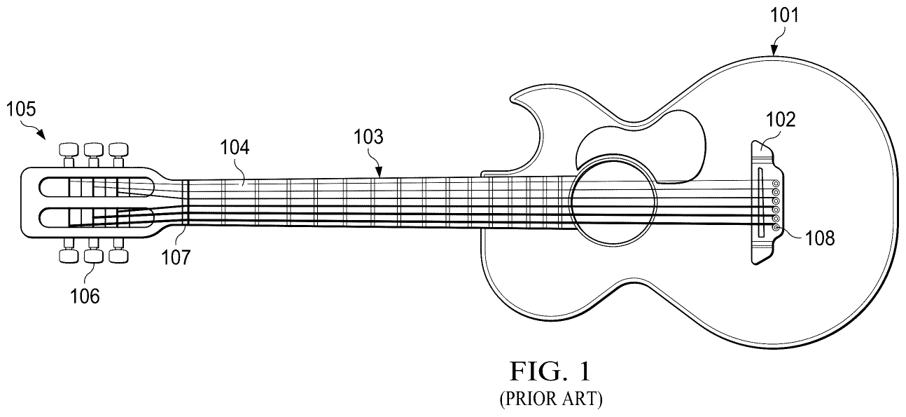

FIG. 2 is a perspective view of the invention;

FIG. 3 is a first, rear view of the invention;

FIG. 4 is a second, rear view of the invention;

FIG. 5 is a view of the invention positioned on the thigh of a user; and

FIG. 6 is a block diagram of an electronic guitar emulator for use with the invention.

### DETAILED DESCRIPTION

While the making and using of the disclosed embodiments of the invention is discussed in detail below, it should be appreciated that the invention provides many applicable inventive concepts which can be embodied in a wide variety of specific contexts. Some features of the embodiments shown and discussed may be simplified or exaggerated for illustrating the principles of the invention.

The invention is an apparatus, system and method for guitar training. It is a string board for holding 6 or 12 guitar strings, a set of guitar strings strung across a bridge and nut, each of which are positioned on the top surface of the string board; a pedestal or orthogonal extending member having a first end and a second end, the first end coupled to the bottom surface of the string board; a belly plate with a top surface and a bottom surface; the second end of the pedestal being coupled to the top surface of the belly plate; and the belly plate have a flat or generally curved contour configured to rest against the belly of the user. Further included is a thigh brace having a thigh brace extension portion coupled at a first end to the string board and a second end coupled to a curved portion operable to rest the invention on the thigh of the user. A first slot and second slot are provided through the belly plate to allow passage of a nylon web belt that is used to secure the invention against the midsection of the user's body. The strings are non-functional acoustically as the purpose is solely to practice right hand (for right handed players) guitar picking, although the strings can be coupled to sensors or switches operable to trigger an electronic sound representation of the picked string.

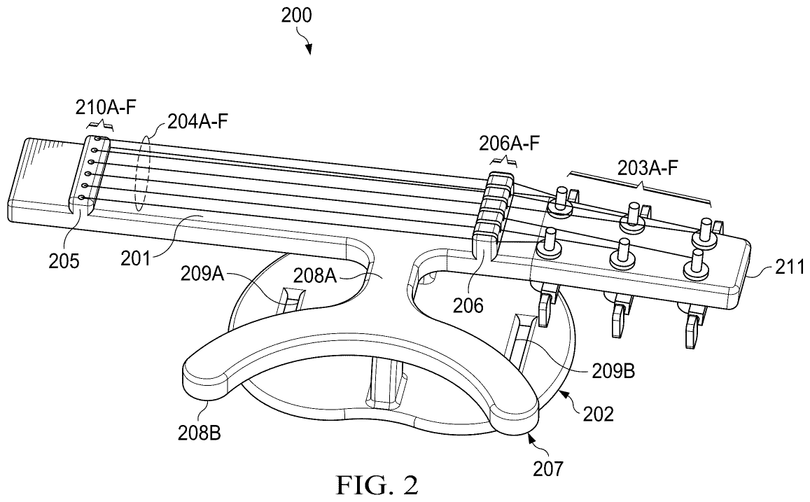

Referring now to the top, perspective view of the invention as seen in FIG. 2, the invention 200 is an apparatus for guitar training. It comprises a string board 201 for holding 6 or 12 guitar strings, as shown with 6 strings 204A-F, the set of guitar strings 204A-F strung across a bridge 205 and nut 206, each of which are positioned on the top surface of the string board 201. String board 201 includes headstock 211 on which tuning pegs are positioned 203A-F are positioned. Bridge 205 includes apertures 210A-F to allow the threading of guitar strings 204A-F therethrough. Guitar strings 204A-F are secured at one end respectively thereof using stoppers that are larger in size than the apertures 210A-F. Nut 206 includes horizontal channels 206A-F through which the portions of guitar strings 204A-F opposite the portions that are threaded through apertures 210A-F traverse, and then are tightened at tuning pegs 203A-F.

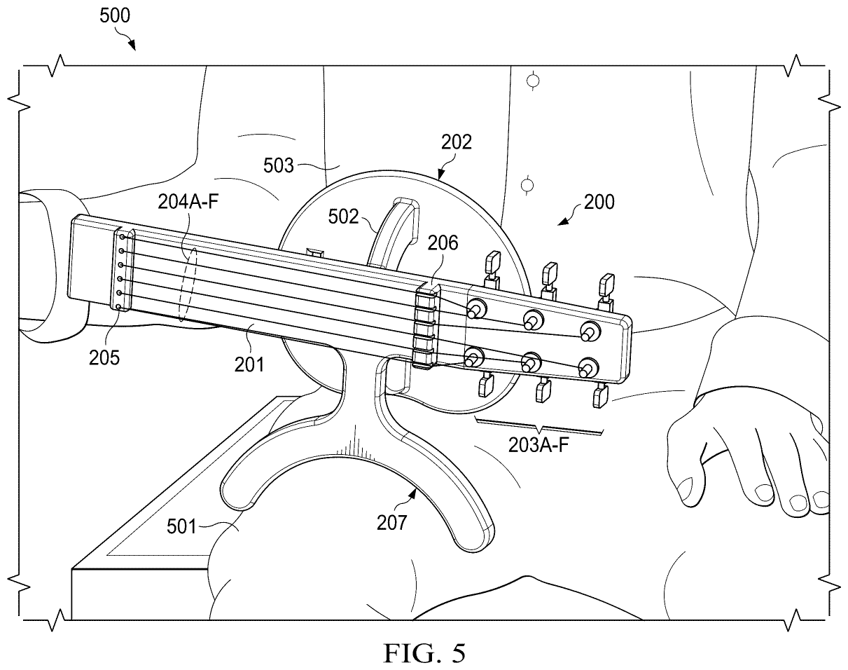

Belly plate 202 has a top surface and a bottom surface. As seen in FIG. 5, an orthogonal extending member 502 has a first end and a second end. The first end is coupled to the rear surface of the string board 201 and the second end of the orthogonal extending member 502 is coupled to the top surface of belly plate 202. Belly plate 202 has a flat or generally curved contour configured to rest against the belly 503 of the user.

Continuing with FIG. 2, the invention further comprises a thigh brace 207 having a thigh brace extension portion 208A coupled at a first end to the string board 201 and a second end coupled to a curved portion 208B enabling the user to rest the invention on their thigh 501. The invention further comprises slots in the belly plate adapted to receive a belt. A first slot 209A and second slot 209B are provided through the belly plate 202 to allow passage of a nylon web belt that is used to secure the invention against the midsection of the user's body 503. The strings are non-functional acoustically as the purpose is solely to practice right hand (for right handed players) guitar picking, although the strings can be coupled to sensors or switches operable to trigger an electronic sound representation of the picked string.

The bridge 205 and nut 206 height above the surface of the string board can be adjusted. The apertures and channels for each of the strings are spaced as they would on a traditional acoustic guitar. The tuning pegs 203A-F are used to tighten the strings.

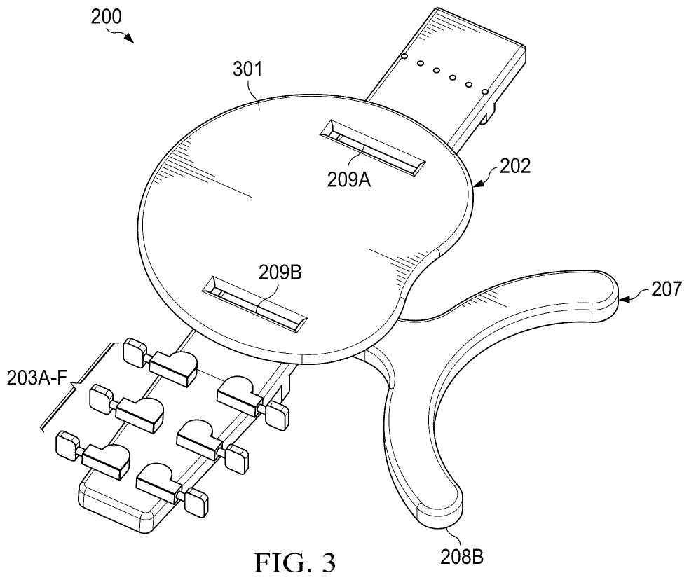

Referring now to the first, rear view of the invention 200 as seen in FIG. 3, the belly plate 202 has a bottom surface 301. Belly plate's 202 bottom surface 301 comprises a flat or generally curved contour configured to rest against the belly 503 of the user. Thigh brace 207 has a curved portion 208B enabling the user to rest the invention on their thigh. The invention further comprises slots in the belly plate adapted to receive a belt. A first slot 209A and second slot 209B are provided through the belly plate 202 to allow passage of a nylon web belt that is used to secure the invention against the midsection of the user's body. The tuning pegs 203A-F include capstan mechanisms operable to allow tightening of the guitar strings.

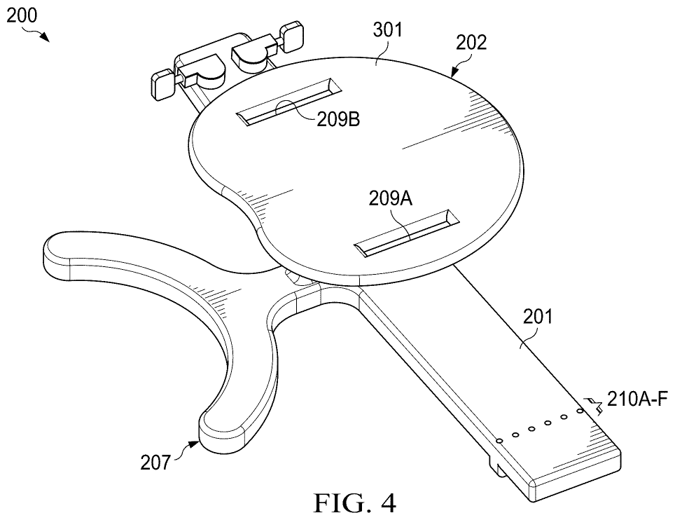

Referring now to the second, rear view of the invention 200 as seen in FIG. 4, the belly plate 202 has a bottom surface 301. Belly plate's 202 bottom surface 301 comprises a flat or generally curved contour configured to rest against the belly 503 of the user. Thigh brace 207 has a curved portion 208B enabling the user to rest the invention on their thigh. The invention further comprises slots in the belly plate adapted to receive a belt. A first slot 209A and second slot 209B are provided through the belly plate 202 to allow passage of a nylon web belt that is used to secure the invention against the midsection of the user's body. The bridge includes apertures 210A-F to allow the threading of guitar strings 204A-F therethrough. Guitar strings are secured using stoppers that are larger in size than the apertures 210A-F.

FIG. 5 shows invention 200 resting on the thigh 501 of a user 500. Belly plate 202 is resting against the midsection 503 of the user. A pedestal or orthogonal extending member 502 has a first end and a second end. The first end is coupled to the bottom surface of the string board 201 and the second end of the pedestal is coupled to the top surface of belly plate 202. Belly plate 202 has a flat or generally curved contour configured to rest against the belly 503 of the user.

The invention 200 comprises a string board 201 for holding 6 or 12 guitar strings, as shown with 6 strings 204A-F, the set of guitar strings 204A-F strung through and across a bridge 205 and nut 206, each of which are positioned on the top surface of the string board 201. Bridge 205 includes apertures 210A-F to allow the threading of guitar strings 204A-F therethrough. Guitar strings 204A-F are secured at the bridge end respectively thereof using stoppers that are larger in size than the apertures 210A-F. Nut 206 includes horizontal channels through which the portions of guitar strings 204A-F opposite the portions that are threaded through apertures 210A-F traverse, and then are tightened at tuning pegs 203A-F.

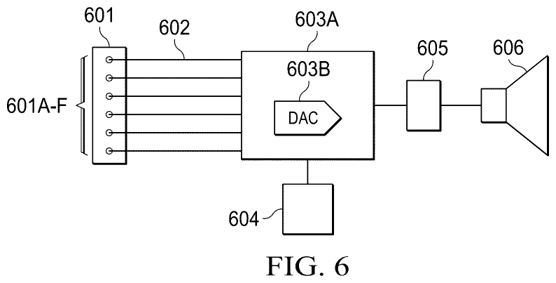

Referring now to FIG. 6, in an embodiment, at least one of the bridge 205 or nut 206 includes a string sensor 601 for sensing if a guitar string has been plucked or picked or strum, and in such case, which string 601A-F has been plucked or strummed. The string sensor is coupled via a bus 602 to a processor 603A, the processor adapted to convert a digital file from a memory 604 to an analog signal in digital to analog converter 603B for amplification by an amplifier 605 and emission from a speaker 606. The memory 604 is operable to hold programs corresponding to different audio signals mapped to each string on the invention 200.

In this manner, synthesized guitar notes can be generated when plucking the strings, the notes being emitted from a speaker on the invention that is coupled to a pickup coil that can sense when a guitar string has been plucked. In this embodiment, there is a pickup coil or strain gauge that senses when a string is plucked. The pickup coil or strain gauge comprises a set of sensors. Typically, for a 6 string guitar, there are 6 sensors and for a 12 string guitar, there are 12 sensors. The pickup coil or strain gauge is coupled to a bus then to a microprocessor. The microprocessor is coupled to a memory that holds data files. The memory holds different programs that map each string, via a corresponding sensor in the pickup coil, to an audio file. The audio file corresponds to the string. For example, the top base string on a 6 string guitar is E2, which corresponds to a frequency of 82.41 Hertz (or cycles per second). One map in the memory correlates the six strings on a standard guitar to output audio files to the following frequencies: E2 (82.41 Hz), A2 (110.00 Hz), D3 (146.83 Hz), G3 (196.00 Hz), B3 (246.94 Hz), and E4 (329.63 Hz). When a string is plucked, the corresponding digital data file is selected, then processed by a digital to audio converter. The analog audio file is then amplified in an amplifier, conditioned as necessary, then applied to a speaker.

Other programs in memory correspond to the different notes played by a guitar when a certain chord is being selected, as would be done in an actual guitar on the neck of the guitar. Common chords are G, C, E minor and D. Any number of chords can be selected which then would change the frequency of the note (hence selected digital data file) of each string when it is plucked. Such programs can also be used to prompt the user to strum up or down and to strum all the strings or a subset of strings and sense if the user has properly followed the instructions. If the instructions have been followed, then an audible prompt is emitted letting the user know. If the instructions have not been followed, then a audible prompt may tell the user to try again.

The components described above can be implemented in a synthesizer. A synthesizer is an electronic musical instrument that generates audio signals. Synthesizers typically create sounds by generating waveforms through methods including subtractive synthesis, additive synthesis and frequency modulation synthesis. The synthesizer includes digital files that store data, that when converted into audio, represent a variety of notes that would be generated by a guitar. One program can store the notes corresponding to the strings, from top to bottom of E, A, D, G, B, E. Alternatively, a program can loaded from memory into the CPU to map barre chords to strings.

One map in the memory correlates the six strings on a standard guitar to output audio files to the following frequencies: E2 (82.41 Ilz), A2 (110.00 Hz), 03 (146.83 Hz). GJ (196.00 Hz), B3 (246.94 Hz). and E4 (329.63 Hz). When a string is plucked, the corresponding digital data file is selected. then processed b) a digital to audio converter. The analog audio file is then amplified in an amplifier, conditioned as necessary, then applied to a speaker.

Other programs in memory correspond to the different notes played by a guitar when a certain chord is being selected, as would be done in an actual guitar on the neck of the guitar. Any number of chords can be selected which then would change the frequency of the note (hence selected digital data file) of each string when it is plucked. Such programs can also be used to prompt the user to strum up or down and to strum all the strings or a subset of strings. Other programs can provide one of a plurality of tempos for the user to strum or pick along with. Alternatively, a program can provide one of a plurality of tempos, wherein at certain times during the program. a chord change automatically occurs, the chords being correlated to a song. In this way. as the program plays, the chord changes are made according to the tempo.

The audio signal emitted by the speaker 606 of the invention 202 depends on which string is plucked and which chord from the program that the user has selected. If the user wants to strum along with a song. then the program causes the chords to change as the song progresses.

There are hundreds of chords and variations, all of which can be stored in the memory. Different programs can be loaded into the sound synthesizer to provide, for example, a voice telling the user to pick a certain string, and then if a signal from the string sensor or pickup coil senses the correct string being plucked, the user is congratulated. Otherwise, if the wrong string is plucked, the user is told to try again.

The guitar training apparatus further comprises an electronic module coupled to a sensor on one of the bridges. the sensor operable to detect when a specific string is plucked. the electronic module comprising a processor, bus, memory, digital to analog converter (DAC), amplifier and speaker or transducer, the sensor coupled to the processor via a bus: the memory is operable to store computer programs comprising code in the form of digital files representing notes of a guitar: the sensor correlated to a string operable to trigger the processor to fetch the corresponding digital file representing a note. The DAC converts the digital file to an analog signal that is amplified and then applied to an audio speaker or transducer. The strings plucked or strummed can be saved by the processor in a corresponding write memory for replay by the user to review their progress in training.

Slots can be included in the belly plate to allow the user to strap the invention around their midsection. Slots can also be included on the top plate to receive a wrist band to hold the wrist in place while practicing.

The invention is a guitar training apparatus having a string board with a top surface, bottom surface, a upper edge and a lower edge. An orthogonal connecting member having a first end and a second end is couple do the string board, the first end coupled to the rear surface of the string board. A belly plate having a top surface and a bottom surface is also coupled to the orthogonal commencing member—specifically, the second end of the orthogonal connecting member is coupled to the top surface of the belly plate. A thigh brace is coupled to the string board, that is, the a thigh brace extension portion with a first end is coupled at an upper end to the string board and a second end coupled to a curved member enabling the user to rest the invention on their thigh. There is a bridge and a nut on the top surface of the string board and a set of guitar strings strung across the bridge and the nut on the top surface of the string board. The invention can also include slots in the belly plate adapted to receive a belt. At least one of the bridge or the nut can include a string sensor for sensing if a guitar string has been plucked or picked or strummed, and in such case, which string has been plucked, picked or strummed. The string sensor is coupled via a bus to a processor, the processor adapted to convert a digital file from a memory to an analog signal for amplification and emission from a speaker. A memory is adapted to hold programs corresponding to different audio signals mapped to each string on the invention. An electronic module can be coupled to a sensor proximate the bridge or the nut, the sensor operable to detect when one of the guitar strings in the set is plucked. The electronic module can include a processor, a bus, a memory, the bus coupling the processor and the memory a digital to analog converter (DAC) coupled to or within the processor; an amplifier coupled to the DAC; and a speaker or transducer coupled to the amplifier, wherein the memory is operable to store computer programs comprising code in the form of digital files, one or more digital files correlating a note to one in the set of guitar string. In such case, the plucking of one in the set of guitar strings is operable to trigger the processor to fetch the corresponding digital file representing a note; and the DAC is operable to convert the digital file to an analog signal that is amplified and then applied to an audio speaker or transducer. When a string is plucked or strummed, the action can be saved by the processor in a corresponding write memory for replay by the user to review their progress in training.

The invention is also a musical training apparatus that has a string board for holding guitar strings, the string board having a head stock positioned proximate an end thereof. It also includes tuning pegs positioned on and through the headstock, a bridge positioned proximate a first end of the string board and a nut positioned proximate a second end of a string board near the headstock.

A set of guitar strings are strung across the bridge and nut, each of such strings positioned on the top surface of the string board. An orthogonal extending member having a first end and a second end, is coupled at the first end to the rear surface of the string board. A belly plate having top surface and a bottom surface is coupled to the second end of the orthogonal extending member at the top surface of belly plate. A thigh brace having a thigh brace extension portion couples a lower edge of the string board to a curved member. The belly plate has a flat or generally curved contour configured to rest against the midsection of a user. The bridge includes apertures to allow the threading of the guitar strings therethrough. Guitar strings are respectively secured at one end thereof using stoppers that are larger in size than the apertures. The nut includes horizontal channels through which the portions of guitar strings opposite the portions that are threaded through apertures traverse. The belly plate can have a first slot and a second slot to allow passage of a belt to secure the invention against the midsection of a user's body. The guitar strings are each coupled to at least one sensor operable to trigger an electronic sound representation of the picked string. Each string sensor is coupled via a bus to a processor, the processor adapted to convert a digital file from a memory to an analog signal for amplification and emission from a speaker. A memory is operable to hold programs corresponding to different audio signals mapped to each string on the invention. An electronic module coupled to a sensor proximate the bridge or the nut, the sensor operable to detect when one of the guitar strings in the set is plucked, the electronic module further includes a processor, a bus, a memory, the bus coupling the processor and the memory, a digital to analog converter (DAC) coupled to or within the processor; an amplifier coupled to the DAC; and a speaker or transducer coupled to the amplifier.

The memory is operable to store computer programs comprising code in the form of digital files, one or more digital files correlating a note to one in the set of guitar strings, and wherein the plucking of one in the set of guitar strings is operable to trigger the processor to fetch the corresponding digital file representing a note. The DAC is operable to convert the digital file to an analog signal that is amplified and then applied to an audio speaker or transducer. When a guitar string is plucked or strummed, the action can be saved by the processor in a corresponding write memory for replay by the user to review their progress in training.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the invention and the system that implements the invention without departing in any way from the spirit and scope of the invention.

We claim:

1. A guitar training apparatus comprising:
a string board having a top surface, bottom surface, a upper edge and a lower edge;
an orthogonal connecting member having a first end and a second end, the first end coupled to the rear surface of the string board;
a belly plate having a top surface and a bottom surface, the second end of the orthogonal connecting member coupled to the top surface of the belly plate;
a thigh brace having a thigh brace extension portion having a first end coupled at an upper end to the string board and a second end coupled to a curved member enabling the user to rest the invention on their thigh;
a bridge and a nut on the top surface of the string board; and
a set of guitar strings strung across the bridge and the nut on the top surface of the string board.

2. The apparatus of claim 1, further comprising slots in the belly plate adapted to receive a belt.

3. The apparatus of claim 1, wherein at least one of the bridge or the nut includes a string sensor for sensing if a guitar string has been plucked or picked or strummed, and in such case, which string has been plucked, picked or strummed.

4. The apparatus of claim 3, wherein the string sensor is coupled via a bus to a processor, the processor adapted to convert a digital file from a memory to an analog signal for amplification and emission from a speaker.

5. The apparatus of claim 4, further comprising a memory adapted to hold programs corresponding to different audio signals mapped to each string on the invention.

6. The apparatus of claim 1, further comprising an electronic module coupled to a sensor proximate the bridge or the nut, the sensor operable to detect when one of the guitar strings in the set is plucked, the electronic module further comprising:
a processor,
a bus,
a memory, the bus coupling the processor and the memory
a digital to analog converter (DAC) coupled to or within the processor;
an amplifier coupled to the DAC; and
a speaker or transducer coupled to the amplifier, wherein the memory is operable to store computer programs comprising code in the form of digital files, one or more digital files correlating a note to one in the set of guitar strings,
the plucking of one in the set of guitar strings operable to trigger the processor to fetch the corresponding digital file representing a note; and
the DAC operable to convert the digital file to an analog signal that is amplified and then applied to an audio speaker or transducer.

7. The apparatus of claim 6, wherein when a string is plucked or strummed, the action can be saved by the processor in a corresponding write memory for replay by the user to review their progress in training.

8. A musical training apparatus, comprising:
a string board for holding guitar strings, the string board having a head stock positioned proximate an end thereof;
tuning pegs positioned on and through the headstock;
a bridge positioned proximate a first end of the string board;
a nut positioned proximate a second end of a string board near the headstock;
a set of guitar strings strung across the bridge and nut, each of such strings positioned on the top surface of the string board;
an orthogonal extending member having a first end and a second end, the first end being coupled to the rear surface of the string board; and
a belly plate having top surface and a bottom surface, the second end of the orthogonal extending member being coupled to the top surface of belly plate; and
a thigh brace having a thigh brace extension portion coupling a lower edge of the string board to a curved member.

9. The musical training apparatus of claim 8, wherein the belly plate has a flat or generally curved contour configured to rest against the midsection of a user.

10. The musical training apparatus of claim 9, wherein the bridge includes apertures to allow the threading of the guitar strings therethrough.

11. The musical training apparatus of claim 10, wherein guitar strings are respectively secured at one end thereof using stoppers that are larger in size than the apertures.

12. The musical training apparatus of claim 8, wherein the nut includes horizontal channels through which the portions of guitar strings opposite the portions that are threaded through apertures traverse.

13. The musical training apparatus of claim 12, further comprising belly plate having a first slot and a second slot to allow passage of a belt to secure the invention against the midsection of a user's body.

14. The musical training apparatus of claim 8, wherein the guitar strings are each coupled to at least one sensor operable to trigger an electronic sound representation of the picked string.

15. The musical training apparatus of claim 14, wherein each string sensor is coupled via a bus to a processor, the processor adapted to convert a digital file from a memory to an analog signal for amplification and emission from a speaker.

16. The musical training apparatus of claim 15, further comprising a memory operable to hold programs corresponding to different audio signals mapped to each string on the invention.

17. The musical training apparatus of claim 14, further comprising an electronic module coupled to a sensor proximate the bridge or the nut, the sensor operable to detect when one of the guitar strings in the set is plucked, the electronic module further comprising:
a processor,
a bus,
a memory, the bus coupling the processor and the memory
a digital to analog converter (DAC) coupled to or within the processor;
an amplifier coupled to the DAC; and
a speaker or transducer coupled to the amplifier.

18. The musical training apparatus of claim 17, wherein the memory is operable to store computer programs comprising code in the form of digital files, one or more digital files correlating a note to one in the set of guitar strings, and wherein the plucking of one in the set of guitar strings is operable to trigger the processor to fetch the corresponding digital file representing a note.

19. The musical training apparatus of claim 18, wherein the DAC is operable to convert the digital file to an analog signal that is amplified and then applied to an audio speaker or transducer.

20. The musical training apparatus of claim 18, wherein when a guitar string is plucked or strummed, the action can be saved by the processor in a corresponding write memory for replay by the user to review their progress in training.
